(19) United States
(12) Patent Application Publication
(10) Pub. No.: US 2018/0294128 A1
(43) Pub. Date: Oct. 11, 2018

(54) EXTENDED PROTECTION FOR VEHICLE

(71) Applicant: GLORYTECH TECHNOLOGY CO., LTD., Taoyuan City (TW)

(72) Inventor: HUAN-YAO KU, TAOYUAN CITY (TW)

(21) Appl. No.: 15/480,380

(22) Filed: Apr. 6, 2017

(51) Int. Cl. H01H 85/20; H01H 85/04

(52) U.S. Cl. CPC H01H 85/2015; H01H 2231/026; H01H 85/04

(57) ABSTRACT

An extended protection device for a vehicle includes: a housing, three conductive wires configured therein, the three conductive wires respectively being a first conductive wire, second conductive wire and third conductive wire extended outward form one end of the housing, another end of the housing configured with a fuse slot, and a combination portion configured on the outside of the fuse slot; a protection element, constituted by two sets of safety fuses, and in corresponding combination with the fuse slot, allowing the protection element to be in electric connection with the first conductive wire, second conduction wire and third conductive wire; and a cover, covered correspondingly on the combination portion of the housing for the protection of the protection element.

### TECHNICAL FIELD OF THE INVENTION

The present invention relates to an extended protection for a vehicle, and more particularly to a vehicle extended protection with a protection element constituted by two sets of safety fuses installed inside a housing, using the housing to protect the protection element, allowing it to be in electric connection with automotive electronics, and extending limited automotive fuse space in a vehicle outward.

### DESCRIPTION OF THE PRIOR ART

Safety fuses, also known as fusible cutouts, are blown to protect circuits when circuit currents are abnormal and exceed their rated values.

Today's general fuses for vehicle are roughly divided into two types of fast-blown fuses and slow-blown fuses, and common car fuses have high current fuses and low current fuses. The low current fuses are generally easier to accessible, roughly divided into chip fuses (including automotive fuse box mini fuses), plug-in fuses, screw-type fuses and tube fuse box flat-panel fuses. Among these, chip fuses can carry small current, short pulse current, such as headlight circuit, rear glass defrost; the conductor inside a chip fuse is made of metal similar to solder, the melting point of which is lower than the ones of ordinary wires, where the size of the conductor must be passed through a very precise calibration so that enough heat can be generated to blow the conductor and break the circuit when the rated current is reached.

However, electronics in modern cars become more and more, but automotive fuses insertion spaces in cars are limited; automotive fuses must be installed correspondingly to extra car electronics in the limed automotive fuses spaces for the protection thereof when they are added in cars.

### SUMMARY OF THE INVENTION

The main object of the present invention is to provide an extended protection for a vehicle, configuring a protection element constituted by two sets of safety fuses in a housing, protecting the protection element through the housing, allowing the protection element to be in electric connection with the automotive electronics, and extending limited automotive fuse space in a vehicle outward.

To achieve the object mentioned above, the present invention proposes an extended protection for a vehicle, including: a housing, three conductive wires configured therein, the three conductive wires respectively being a first conductive wire, second conductive wire and third conductive wire extended outward form one end of the housing, another end of the housing configured with a fuse slot, and a combination portion configured on the outside of the fuse slot; a protection element, constituted by two sets of safety fuses, and in corresponding combination with the fuse slot, allowing the protection element to be in electric connection with the first conductive wire, second conduction wire and third conductive wire; and a cover, covered correspondingly on the combination portion of the housing for the protection of the protection element.

According to the extended protection mentioned above, the first conductive wire is in electric connection with a first load end, the second conductive wire is a positive terminal, and the third conductive wire is in electric connection with a second load end.

According to the extended protection mentioned above, the protection element has three conductive sheets respectively being a first conductive sheet, second conductive sheet and third conductive sheet, the first conductive sheet and second conductive is one set of safety fuses, and the second conductive sheet and third conductive sheet is another set of safety fuses; the protection element in corresponding combination with the fuse slot allows the first conductive sheet to be in electric connection with the first conductive wire, the second conductive sheet the second conductive wire, and the third conductive sheet the third conductive wire.

### BRIEF DESCRIPTION OF THE DRAWINGS

FIG. 1 is a perspective view of the present invention;

FIG. 2 is an exploded view of the present invention; and

FIG. 3 is a perspective view of the present invention upon implementation.

### DETAILED DESCRIPTION OF THE PREFERRED EMBODIMENTS

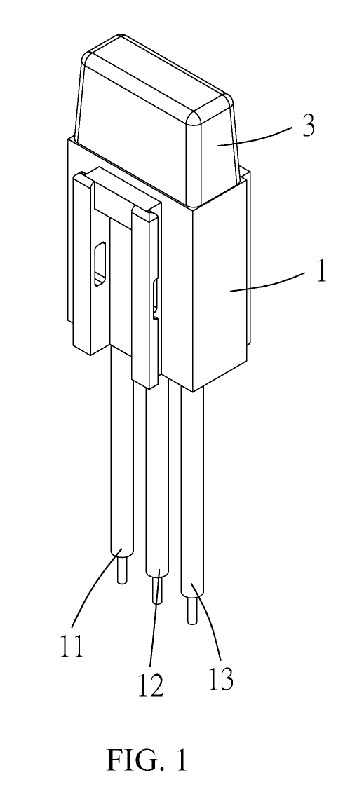

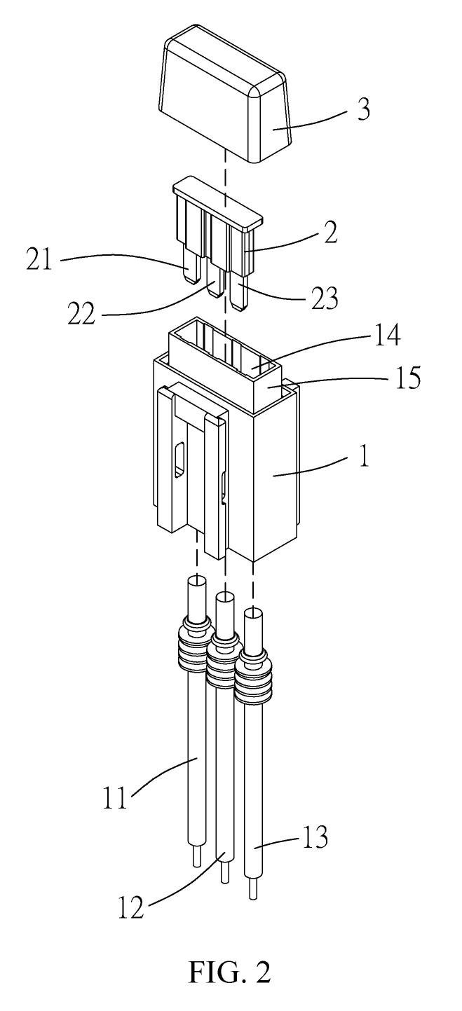

Referring to FIGS. 1 to 3, an extended protection for a vehicle of the present invention includes a housing 1, inside which three conductive wires are installed. Here, the three conductive wires respectively are a first conductive wire 11, second conductive wire 12 and third conductive wire 13 extended outward from one end of the housing 1, where the first conductive wire 11 is in electric connection with a first load end, the second conductive wire 12 is a positive terminal, and the third conductive wire 13 is in electric connection with a second load end. Furthermore, another end of the housing 1 is configured with a fuse slot 14, the outside of which is configured with a combination portion 15. Furthermore, a protection element 2 constituted by two sets of safety fuses is in corresponding combination with the fuse slot 14, allowing the protection element 2 to be in electric connection with the first conductive wire 11, second conductive wire 12 and third conductive wire 13. Furthermore, a cover 3 is covered correspondingly on the combination portion 15 of the housing 1 for the protection of the protection element 2.

Furthermore, the protection element 2 has three conductive sheets respectively being a first conductive sheet 21, second conductive sheet 22 and third conductive sheet 23, where the first conductive sheet 21 and conductive sheet 22 is one set of safety fuses, and the second conductive sheet 22 and third conductive sheet 23 another set of safety fuses; the protection element 2 in corresponding combination with the fuse slot 14 allows the first conductive sheet 21 to be in electric connection with the first conductive wire 11, the second conductive sheet 22 the second conductive wire 12, and third conductive sheet 23 the third conductive wire 13.

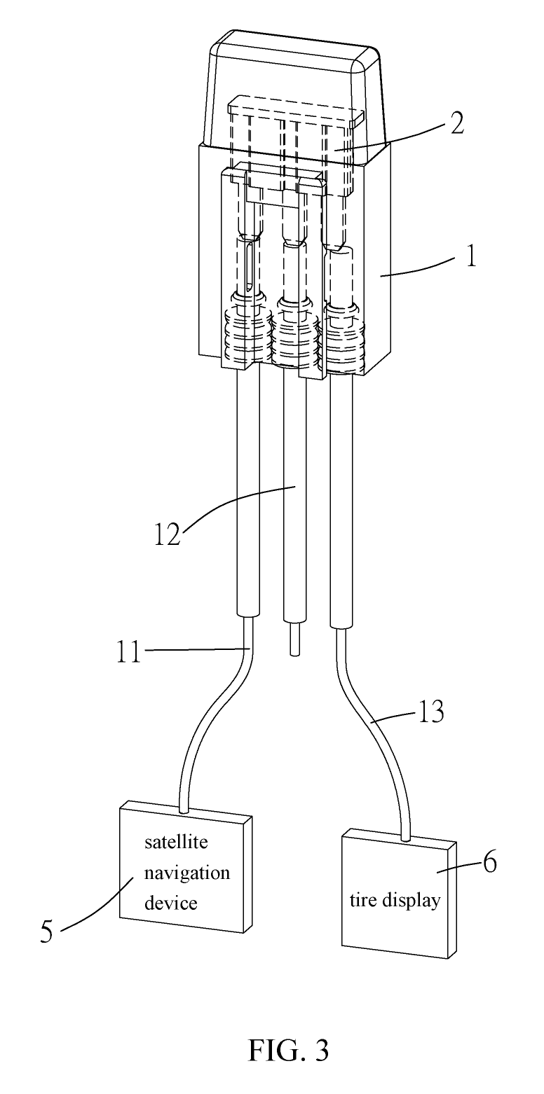

Referring to FIG. 3 again, which is a schematically perspective view of the present invention upon implementation, the second conductive wire is in electric connection with a positive terminal upon the use of the extended protection for a vehicle of the present invention, and the first conductive wire 11 is the first load end, the second conductive wire 12 the positive terminal and the third conductive wire 13 the second load end as shown in FIG. 3, allowing, for example, the first conductive wire 11 to be in electric connection with a satellite navigation device 5, and the third conductive wire 13 a tire display 6. Whereupon, in the vehicle extended protection of the present invention, the housing 1 is configured with the protection element 2 constituted by the two safety fuses, the protection element 2 being protected by the housing 1, and the protection element 2 is allowed to be in electric connection with two different automotive electronics, thereby extending the original limited safety fuse space outward.

1: A protection device for a vehicle, comprising:
a housing;
a first conductive wire having a first circularly planar surface at a front end thereof and in the housing;
a second conductive wire having a second circularly planar surface at a front end thereof and in the housing;
a third conductive wire having a third circularly planar surface at a front end thereof and in the housing; and
a protection element, constituted by two sets of safety fuses, allowing said protection element to be in electric connection with the first conductive wire, second conduction wire and third conductive wire, wherein the protection element has a first sheet in the housing and in contact with the first circularly planar surface, a second sheet in the housing and in contact with the second circularly planar surface and a third sheet in the housing and in contact with the third circularly planar surface.

2: The protection device of claim 1, wherein the first conductive wire couples to a first load end, the second conductive wire couples to a positive terminal and the third conductive wire couples to a second load end.

3: The protection device of claim 1 comprising a cover joining the housing to cover the protection element.

4: The protection device of claim 2, wherein the first load end comprises a satellite navigation device.

5: The protection device of claim 2, wherein the second load end comprises a tire display.

6: The protection device of claim 2, wherein the first load end comprises a satellite navigation device, and the second load end comprises a tire display.

7: The protection device of claim 1, wherein the second sheet is between the first and third sheets, wherein the first conductive wire couples to a first load end, the second conductive wire couples to a positive terminal and the third conductive wire couples to a second load end.

8: The protection device of claim 7, wherein the first load end comprises a satellite navigation device.

9: The protection device of claim 7, wherein the second load end comprises a tire display.

10: The protection device of claim 7, wherein the first load end comprises a satellite navigation device, and the second load end comprises a tire display.

11: The protection device of claim 1, wherein the first conductive wire couples to a satellite navigation device.

12: The protection device of claim 1, wherein the third conductive wire couples to a tire display.

13: The protection device of claim 1, wherein the second conductive wire couples to a positive terminal.

14: A protection device for a vehicle, comprising:
a housing;
a first conductive wire having a first contact in the housing and coupling to a satellite navigation device;
a second conductive wire having a second contact in the housing and coupling to a positive terminal;
a third conductive wire having a third contact in the housing and coupling to a tire display; and
a protection element, constituted by two sets of safety fuses, allowing said protection element to be in electric connection with the first, second and third conductive wires, wherein the protection element has a first contact in the housing and in contact with the first contact of the first conductive wire, a second contact in the housing and in contact with the second contact of the second conductive wire and a third contact in the housing and in contact with the third contact of the third conductive wire.

15: The protection device of claim 14, wherein the second contact of the protection element is between the first and third contacts of the protection element.

16: The protection device of claim 14 further comprising a cover joining the housing to cover the protection element.

17: A protection device for a vehicle, comprising:
a housing;
a first conductive wire having a first contact in the housing and coupling to a first load end;
a second conductive wire having a second contact in the housing and coupling to a positive terminal;
a third conductive wire having a third contact in the housing and coupling to a second load end; and
a protection element, constituted by two sets of safety fuses, allowing said protection element to be in electric connection with the first, second and third conductive wires, wherein the protection element has a first contact in the housing and in contact with the first contact of the first conductive wire, a second contact in the housing and in contact with the second contact of the second conductive wire and a third contact in the housing and in contact with the third contact of the third conductive wire, wherein the second contact of the protection element is between the first and third contacts of the protection element.

18: The protection device of claim 17 further comprising a cover joining the housing to cover the protection element.

19: The protection device of claim 17, wherein the first load end comprises a satellite navigation device.

20: The protection device of claim 17, wherein the second load end comprises a tire display.
